(19) United States
(12) Patent Application Publication
(10) Pub. No.: US 2026/0350865 A1
(43) Pub. Date: Nov. 5, 2026

(54) EMISSION SPECTRUM WHEEL USER INTERFACE

(71) Applicant: Schlumberger Technology Corporation, Sugar Land, TX (US)

(72) Inventor: Atul Sureka, Pune (IN)

(21) Appl. No.: 19/252,338

(22) Filed: Jun. 27, 2025

(30) Foreign Application Priority Data
Apr. 30, 2025 (IN) 202511041672

(51) Int. Cl. G06T 11/26; G06Q 10/0639

(52) U.S. Cl. CPC G06T 11/26; G06Q 10/0639

(57) ABSTRACT

Generating an emission spectrum wheel user interface includes performing the following operations. For a particular entity, tuples about emissions of the particular entity are obtained. Each tuple includes an amount, an emission type of a plurality of emission types, and an emission category of a plurality of emission categories. The user interface is populated with a circular emissions diagram with emission indicators generated from the tuples. The circular emissions diagram includes a wedge for each emission category of multiple emission categories. Populating the circular emissions diagram includes for each tuple assigning an emission indicator of the emission indicators to a corresponding wedge that corresponds to the emission category in the tuple and setting a radial distance from the center in the wedge of the emission indicator based on the amount in the tuple. The operations further include displaying the user interface.

### CROSS-REFERENCE TO RELATED APPLICATION

This application claims priority to and the benefit of Indian Application No. 202511041672, entitled “EMMISSION SPECTRUM WHEEL USER INTERFACE,” filed Apr. 30, 2025, which is hereby incorporated by reference in its entirety for all purposes.

### BACKGROUND

Carbon auditing is a tool used to assess the carbon footprint of various products and services offered by a business, government, or non-profit entity. Carbon auditing aids in the identification of opportunities for emission reductions. For an entity, different scopes of carbon emissions are considered in the carbon emission auditing process.

The Greenhouse Gas (GHG) Protocol scope classifications refer to the diverse levels of GHG emissions that an organization or entity can account for when measuring and reporting their carbon emissions. The GHG Protocol is a widely recognized accounting tool developed by the World Resources Institute (WRI) and the World Business Council for Sustainable Development (WBCSD) to standardize GHG emissions, accounting, and reporting. The GHG Protocol identifies three scope classifications, commonly known as Scope 1, Scope 2, and Scope 3 emissions. These scopes help organizations understand and categorize their emission sources, enabling them to develop comprehensive emission reduction strategies.

Scope 1 emissions are direct emissions. Direct emissions refer to the emissions resulting from direct actions of the entity. For example, the direct emissions include the operations of the entity facilities and the vehicles.

Scope 2 emissions are one level of indirection, such as purchased electricity, steam, heating and cooling, and other causes of carbon emissions. When an entity consumes electricity, for example, the entity indirectly contributes to the emissions associated with the electricity generation.

Scope 3 emissions are from upstream or downstream activities. For example, upstream activities include purchased goods and services, transportation and distribution of goods purchased by the business, business travels, employee commuting, etc. Downstream activities include the emissions using the processing of sold products of the entity, transportation and distribution of goods, end of life treatment of sold products, and investments made by the entity.

Software applications track and gather information about the emissions. After performing the tracking and gathering, the emissions data is displayed in a user interface. Commonly, the user interface is a table. However, because of the number of various sources of emissions that an entity, especially a large entity, can cause in each of the different scopes, the user interface of the software application is often cluttered and difficult to read. This problem is exacerbated as the user interface should be able to be displayed on a smaller form factor of a mobile display device as well as on a large display device. Thus, a problem exists in defining a user interface that clearly and concisely shows emissions data on a user interface.

### SUMMARY

In general, in one aspect, the emission spectrum wheel user interface includes performing the following operations. For a particular entity, tuples about emissions of the particular entity are obtained. Each tuple includes an amount, an emission type of a plurality of emission types, and an emission category of a plurality of emission categories. The user interface is populated with a circular emissions diagram with emission indicators generated from the tuples. The circular emissions diagram includes a wedge for each emission category of multiple emission categories. Populating the circular emissions diagram includes for each tuple assigning an emission indicator of the emission indicators to a corresponding wedge that corresponds to the emission category in the tuple and setting a radial distance from the center in the wedge of the emission indicator based on the amount in the tuple. The operations further include displaying the user interface.

The emission spectrum wheel user interface may be generated by a computer readable program code on a non-transitory computer readable medium or a computer program product. The computer readable program code may cause a computer system to perform the above operations to generate the user interface.

In general, in one aspect, the emission spectrum wheel user interface includes the following system. A data repository stores tuples about emissions of a particular entity, each tuple including an amount, an emission type of multiple emission types, and an emission category. A computer processor connected to the data repository generates a user interface including a circular emissions diagram that includes emission indicators generated from the tuples. The circular emissions diagram includes a wedge for each of multiple emission categories. The circular emissions diagram includes the following for each of multiple tuples. An emission indicator in a corresponding wedge of the plurality of wedges that corresponds to the emission category in the tuple. The emission indicator is at a radial distance from the center in the wedge defined based on the amount in the tuple.

Other aspects of one or more embodiments will be apparent from the following description and the appended claims.

### BRIEF DESCRIPTION OF DRAWINGS

FIG. 1 shows a diagram of a computing system, in accordance with one or more embodiments.

FIG. 2 shows a diagram of an example user interface showing the emissions diagram in one or more embodiments.

FIG. 3 shows a labeled version of the emissions diagram in the user interface in one or more embodiments.

FIG. 4 shows a flowchart for generating the emissions diagram in the user interface in one or more embodiments.

FIG. 5 shows an example emissions diagram without emissions data and with the scope 3 emissions further segmented in one or more embodiments.

FIG. 6 shows an example emissions diagram with all emission types displayed on a display device in accordance with one or more embodiments.

FIG. 7 shows an example emissions diagram with only a subset of emission types displayed on a display device in accordance with one or more embodiments.

FIG. 8.1 and FIG. 8.2 include a computing system in accordance with one or more embodiments of the invention.

Like elements in the various figures are denoted by like reference numerals for consistency.

### DETAILED DESCRIPTION

One or more embodiments are directed to a circular emissions diagram in accordance with one or more embodiments of the invention. The circular emissions diagram addresses the problem of displaying a large volume of emissions data. The emissions data includes multiple tuple. Each tuple has the emission type, the emission category, and the amount of the emission in the emission type and the emission category. The circular emissions diagram includes multiple wedges. Each wedge corresponds to a particular emissions category. The circular emissions diagram is further configured to show emission indicators for the tuples. Specifically, the emission indicator corresponding to a tuple is assigned to the wedge corresponding to the emission category in the tuple. The radial distance of the emission indicator from the center of the circular emission diagram is based on the amount in the tuple. In some embodiments, the size of the emission indicator is proportional to the amount and the radial distance is proportional to the intensity corresponding to the amount. By having a compact form factor, the emissions diagram presents a large amount of emissions data in an easy to read format that can be displayed on virtually any size of display device.

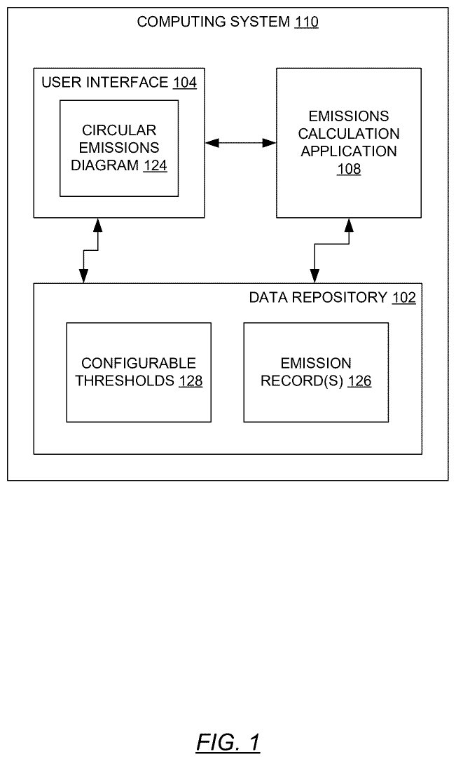

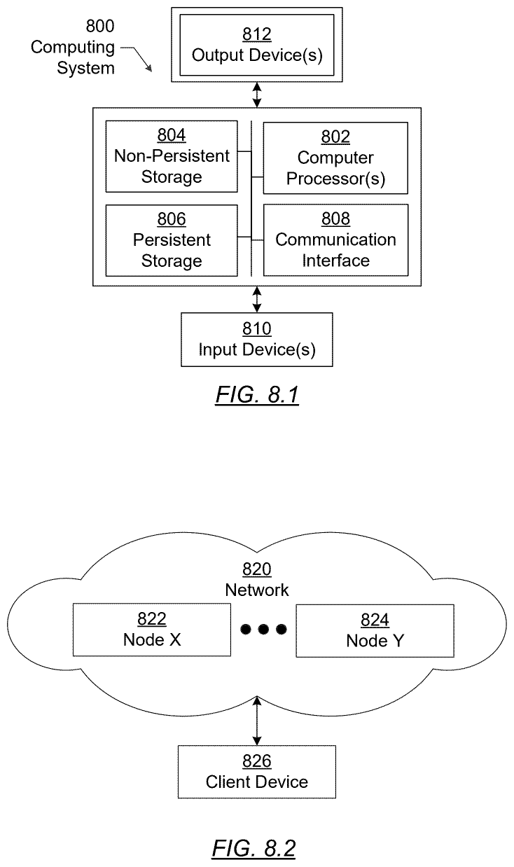

FIG. 1 is a diagram of computing system (110) in accordance with one or more embodiments. The computing system (110) may be the same as the computing system shown in FIG. 8.1 and FIG. 8.2, below. Specifically, the various components of the computing system shown in FIG. 1 operate on and are displayed on the hardware shown in FIG. 8.1 and FIG. 8.2. As shown in FIG. 1, the computing system (110) includes a data repository (102) connected to an emissions calculation application (108) and a user interface (104).

The data repository (102) is a type of storage unit or device (e.g., a file system, database, data structure, or any other storage mechanism) for storing data. The data repository (102) may include multiple different, potentially heterogeneous, storage units and/or devices. The data repository (102) is a repository that stores emission records (126) of a target entity. The emission record may be a direct recording of emissions or a transaction record that records an exchange or interaction of the entity with another entity that results in an emission. The transaction record may be processed to determine one or more emission types and amounts of the emission corresponding to the emission record.

The configurable thresholds (128) are thresholds that are on a value based on the amount of the emission. For example, the configurable thresholds may define what constitutes high, medium, and low emissions. Different configurable thresholds and number of configurable thresholds may be used. Further, configurable thresholds may have equidistant spacing or have unequal distribution.

The emissions calculation application (108) is configured to generate tuples from the emission record(s) (126). For example, the emissions calculation application (108) may include a rules based system that combines transaction records into emission records using a set of rules of attributes in transactions. As another example, the emissions calculation application may include a machine learning model that determines emission data from the emission category. The emissions calculation application (108) further includes an aggregator configured to aggregate emissions along one or more properties to generate an amount of aggregated emissions. For example, the aggregation may be along dates or transactions. The result of the aggregation are one or more tuples.

Specifically, each tuple may be an aggregation of one or more emission records. The tuple is a set of interrelated property values about an emission that relates the properties together. The tuple may be for a particular time frame, a sub-entity of the entity. The properties in the tuples may include the amount of the emission, the emission type of the emission, and the emission category of the emission. The amount may be an aggregated amount, for example, that is aggregated across emission records included in the tuple. For example, the aggregated amount may be a summation or other aggregation.

The emission category is the scope of the emissions. The emission category may be scope 1, scope 2, or scope 3 emissions. The scope of the emissions is defined in the GHG (Greenhouse Gas) Protocol standard.

The emission type is the type of the emitted particles, such as the emitted chemicals. For example, the emission type may be the type of greenhouse gas. By way of some examples, the emission type may Carbon Dioxide (CO₂), Methane (CH₄), Nitrous Oxide (N₂O), Hydrofluorocarbons (HFCs), Perfluorocarbons (PFCs), Sulphur hexafluoride (SF₆), or Nitrogen trifluoride (NF₃). Other emission types may be included without departing from the scope of the invention. Further, some of the aforementioned emission types may be excluded without departing from the scope of the invention.

Other properties of the emissions may be included in the tuple. For example, a property may be a date range of the emission or a sub-entity for which the tuple is created.

The user interface (104) is an interactive interface that includes functionality to receive user input and display output. In one or more embodiments, the user interface (104) includes functionality to display a circular emissions diagram (124). The circular emissions diagram (124) is a diagram that is substantially a circle. The circular emissions diagram may be a two dimensional circle or may be three dimensional (e.g., sphere or cone) with a circle base. In the circular emissions diagram, tuples correspond to individual points rather than wedges. Radial distances from the center in the circular emissions diagram (124) is based on an amount.

While FIG. 1 shows a configuration of components, other configurations may be used without departing from the scope of one or more embodiments. For example, various components may be combined to create a single component. As another example, the functionality performed by a single component may be performed by two or more components.

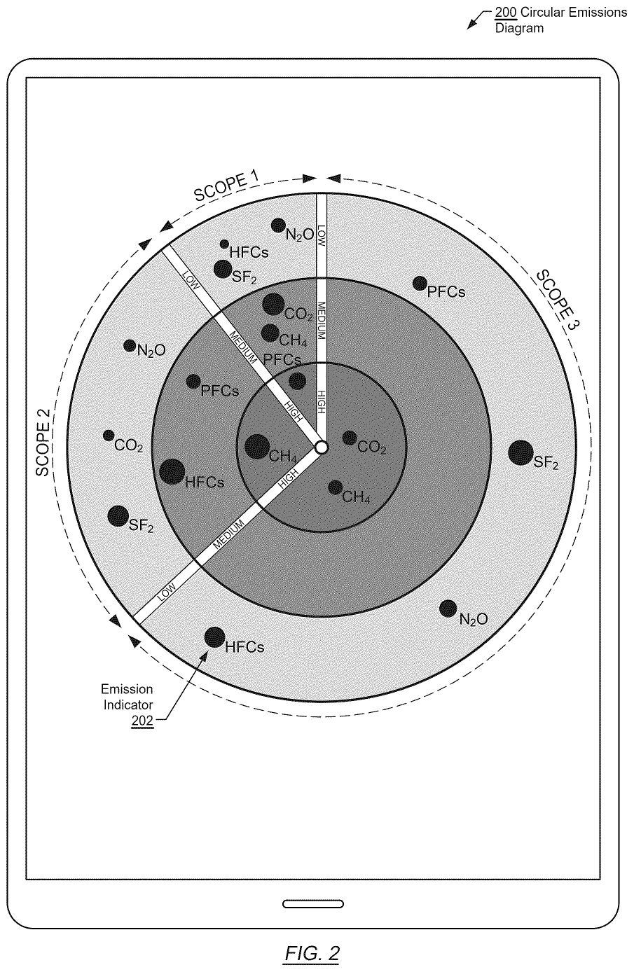

FIG. 2 shows an example circular emissions diagram (200) in accordance with one or more embodiments. As shown in FIG. 2, the circular emissions diagram (200) shows scope 1, scope 2, and scope 3 emissions in separate wedges. The emission indicators (e.g., emission indicator (202)) are the dots (i.e., circles) on the circular emission diagram. Further, as shown in FIG. 2, the circular emission diagram includes multiple concentric circles. Each concentric circle may be a different color or a different shade of a same color to show the severity of the emissions. As such, the concentric circle is color coded to show the severity of the region of the circle. As shown in FIG. 2, the circular emissions diagram shows a concise presentation of the emissions of the entity.

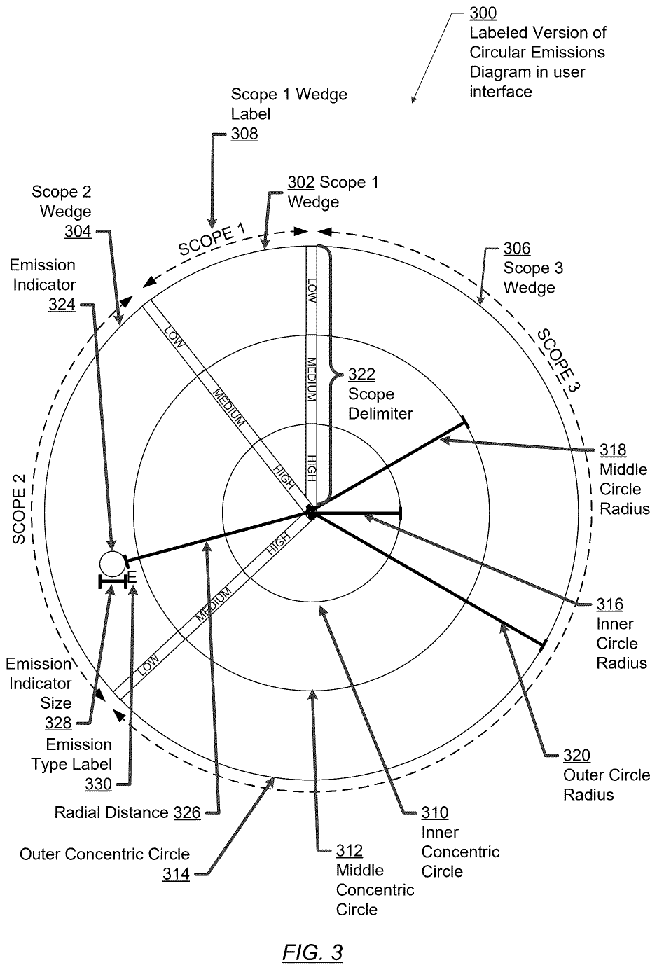

FIG. 3 shows a labeled version (300) of the emissions diagram in the user interface in one or more embodiments. The labeled version may be the same as shown in FIG. 2, but with most of the emission indicators and shading removed for clarity of the figure to allow for the labeling. The thicker lines on the circular emissions diagram are figure labels and not part of the actual circular emissions diagram.

The circular emissions diagram in FIG. 3 is a circle partitioned into wedges (e.g., scope 1 wedge (302), scope 2 wedge (304), scope 3 wedge (306)) with each wedge corresponding to a particular category of emissions. Each wedge extends from the center and ends on the outer edge of the circle. In other words, a wedge, also referred to as a sector or circular sector, is a region that a bound by two radii of the circle and extends to the outer arc. In the example shown in FIG. 3, the size of the wedge matches the relative expected amount of the category of emissions with respect to other categories of emissions. As such, the circular emissions diagram has an underlying pie chart for the relative expected amounts of the category of emissions. The expective amounts may be for a particular industry of the entity, based on historical data of the industry or the entity, or based on other information. Although FIG. 3 shows a pie chart, in some cases, the wedges may be equal sized.

Each wedge (e.g., scope 1 wedge (302), scope 2 wedge (304), scope 3 wedge (306)) also has a wedge label (e.g., scope 1 wedge label (308)). To simplify the FIG., scope 2 wedge label and scope 3 wedge label do not have reference numbers attached. The wedge label is a textual description of the wedge. Further, as shown in FIG. 3, the wedge label may be shown adjacent to an arc (e.g., the dashed line arc in FIG. 3) to demarcate the wedge. The dashing may appear in the actual interface. Thus, the combination of the arcs is an outer dotted circle that is broken and labeled with the wedge labels.

Continuing with FIG. 3, the circular emissions diagram has three concentric circles (e.g., inner concentric circle (310), middle concentric circle (312), outer concentric circle (314)). Each concentric circle corresponds to an individual threshold on a value based on the amount. The threshold is one of the configurable thresholds of FIG. 1. The threshold is proportional to the radius (e.g., inner circle radius (316), middle circle radius (318), outer circle radius (320)) of the concentric circle. The value corresponds to the radial distance, whereby the radial distance is the distance of a location on the circle to the center of the circle.

As shown in FIG. 3, the circular emissions diagram may also include a scope delimiter (322) the value corresponding to radial distance. The scope delimiter (322) is a separation between the wedges. As shown in FIG. 3, the scope delimiter (322) may further be partitioned and include labels to the concentric circles. The labels visually show the thresholds denoted by the concentric circles. Thus, for example, in the diagram of FIG. 3, the greater the emission, the closer to the center. The “high” label denotes the region of high emissions as denoted by a high emission threshold and demarcated by the inner concentric circle (310). The “medium” label denotes the region of medium emissions as denoted by a medium emission threshold and demarcated by the middle concentric circle (312). The “low” label denotes the region of low emissions as denoted by a low emission threshold and demarcated by the outer concentric circle (314).

The aforementioned components of FIG. 3 may correspond to background or portions of the diagram that do not change based on user data. As discussed above, the number and radii of the concentric circles may be configurable based on the configurable thresholds. Further, the wedges may be configurable.

Continuing with FIG. 3, the tuples discussed in reference to FIG. 1 corresponds to an emission indicator (324). Namely, each tuple has a corresponding individual emission indicator that is shown for the tuple. The emission indictor is at a location defined by the radial distance (326), in a wedge corresponding to the emission category in the corresponding tuple. The emission indicator (324) further has an emission indicator size (328). For example, the emission indicator size (328) may be defined by the diameter or the area of the emission indicator. The emission indicator size (328) and the radial distance (326) are based on the amount in the tuple. In one or more embodiments, the radial distance is proportional to the intensity of the tuple, while the emission indicator size is proportional to the amount of the tuple. The intensity is an emissions intensity and corresponds to the standard definition used in the art. The intensity is a function of the amount. An emission type label (330) is adjacent to (e.g., as shown in FIG. 3) or within the emission indicator. The emission type label (330) clearly identifies the emission type in the corresponding tuple. Thus, the emission type label displays the emission type. For example, the emission type label may be a chemical formula of the emission type.

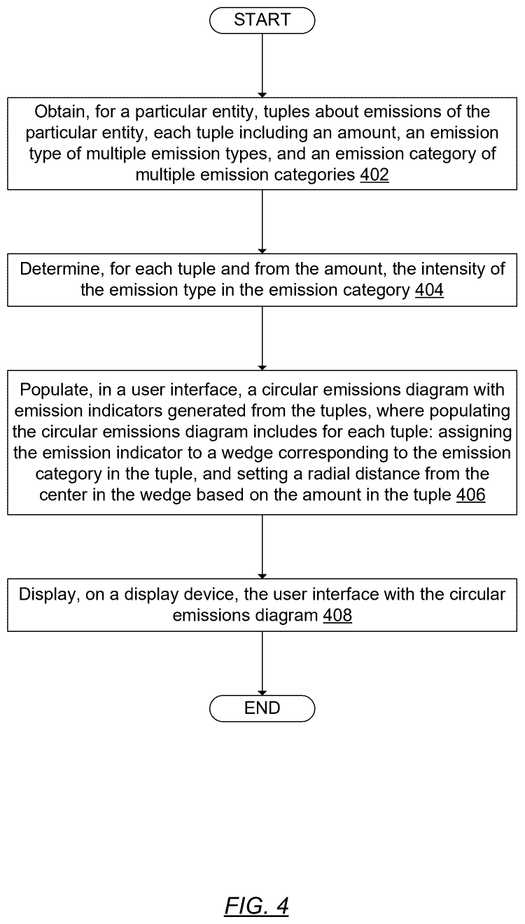

FIG. 4 shows a flowchart for generating the emissions diagram in the user interface in one or more embodiments. The blocks of FIG. 2 may be implemented using the system of FIG. 1 and one or more of the steps may be performed on or received at one or more computer processors. While the various blocks in FIG. 4 are presented and described sequentially, at least some of the steps may be executed in different orders, may be combined or omitted, and at least some of the steps may be executed in parallel.

Block 402 includes obtaining, for a particular entity, tuples about emissions of the particular entity, each tuple including an amount, an emission type of multiple emission types, and an emission category of multiple emission categories. The tuples may be obtained from the emissions calculation application, from the data repository, generated from the emission records, or received via another source.

Block 404 includes determining, for each tuple and from the amount, the intensity of the emission type in the emission category. The intensity may be calculated using a function of the amount in the tuple. For example, the intensity may be calculated by dividing the amount by the total activity metric. For example, the intensity may be the amount of emission divided by the number of items or product produced by the emission. Stated another way, the intensity identifies the amount of emission as compared to the amount of value generated by causing the emission.

Block 406 includes populating, in a user interface, a circular emissions diagram with emission indicators generated from the tuples. Populating the circular emissions diagram includes performing the following operations for each tuple. The emission indicator corresponding to the tuple is assigned to a wedge corresponding to the emission category in the tuple. Further, the radial distance from the center is set in the wedge based on the amount in the tuple. For example, the radial distance may be proportional to the intensity or proportional to the amount. For example, a function of the intensity may be the radial distance of the emission indicator. A function of the amount may be used as the emission indicator size.

Block 408 includes displaying, on a display device, the user interface with the circular emissions diagram. The display device shows the circular emission diagram. Block 408 may be performed by transmitting the circular emission diagram to a user device for display on a display device of the user device. Displaying the circular emission diagram on the display device addresses the user interface problem associated with emissions data by simplifying the manner in which the emissions data is presented.

The various operations of FIG. 4 may be performed automatically, without user involvement. For example, as the system gathers the emission information, the system may present the circular emissions diagram on a dashboard to present the emissions information.

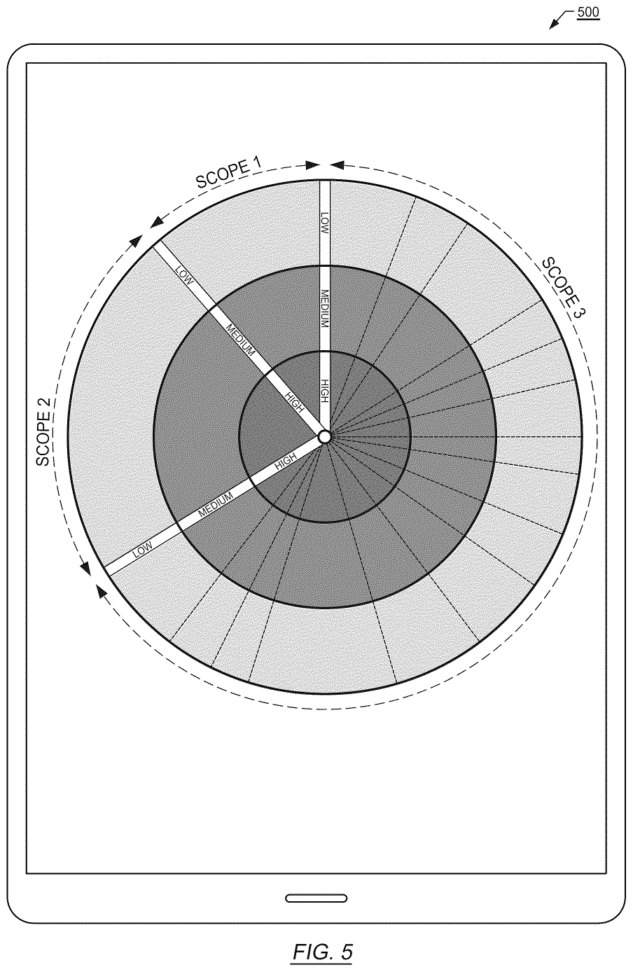

FIG. 5 shows an example emissions diagram (500) without emissions data and with the scope 3 emissions further segmented in one or more embodiments. In the example of FIG. 5, radii are added to the scope 3 wedge to further segment the scope 3 wedges into sub-wedges. Each of the sub-wedges correspond to subcategories of scope 3 emissions. For example, the sub-wedges may each be for one of the corresponding subcategories of purchased goods and services, capital goods, fuel and energy-related activities, upstream transportation and distribution, waste generated in operations, business travel, employee commuting, upstream leased assets, downstream transportation and distribution, processing of sold products, use of sold products, end of life treatment of sold products, downstream leased assets, franchises, and investments. If sub-wedges are shown, the tuples having a scope 3 emission may also include a subcategory information. Sub-wedges may also be used for subcategories of other categories of emissions.

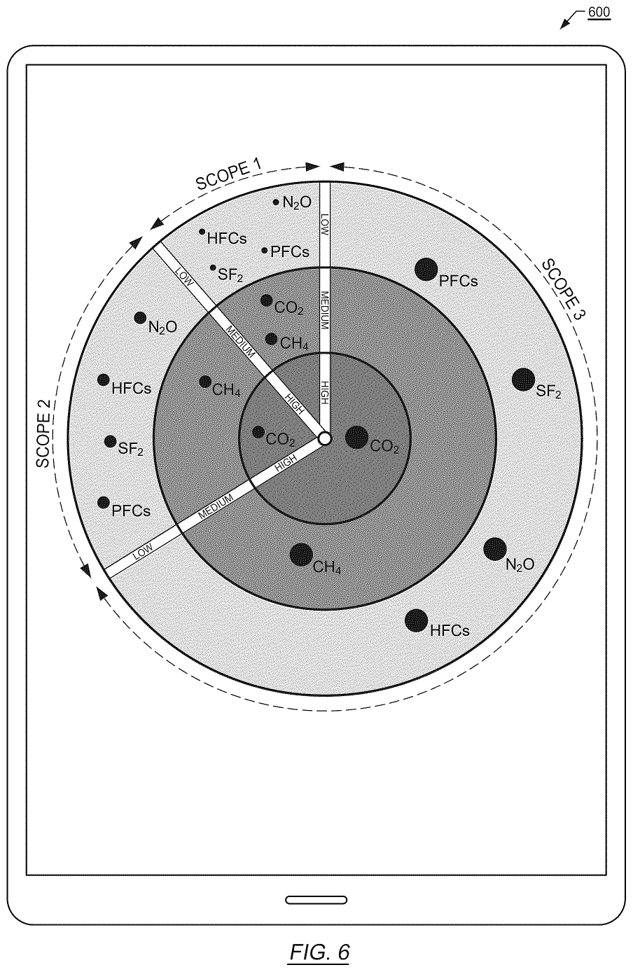

FIG. 6 shows an example circular emissions diagram (600) with all emission types displayed on a display device in accordance with one or more embodiments. As shown, the circular emissions diagram is shown on the display device. The location of the emission indicators within a wedge at the same radial distance is configurable. Further, the location is dependent on the emission information in the corresponding tuple.

In some cases, not all emission indicators are shown. For example, the emission indicators for tuples having an intensity or amount greater than a threshold may be shown while emission indicators for other tuples are hidden. As another example, a user may deselect some emission types from being shown.

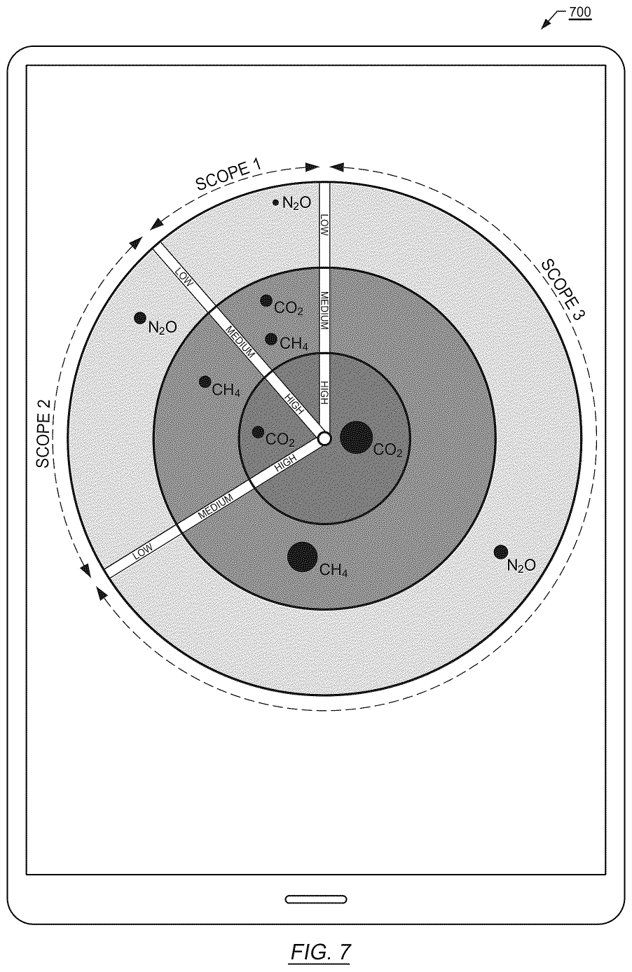

FIG. 7 shows an example circular emissions diagram (700) on a user interface with a display device with only a subset of emission types displayed on a display device in accordance with one or more embodiments. The location of the emission indicators is changed based on the data. The subset is only the portion shown. In the example of FIG. 7, the subset corresponds to the multiple tuples for which each tuple is processed to display a corresponding emission indicator.

The boxes in FIG. 6 and FIG. 7 correspond to the outer bounds of the user interface and the display device.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 8.1, the computing system (800) may include one or more computer processor(s) (802), non-persistent storage device(s) (804), persistent storage device(s) (806), a communication interface (808) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) (802) may be one or more cores, or micro-cores, of a processor. The computer processor(s) (802) includes one or more processors. The computer processor(s) (802) may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (812). The inputs may include text input, audio input, video input, etc., which may be processed and transmitted by the computing system (800) in accordance with one or more embodiments. The communication interface (808) may include an integrated circuit for connecting the computing system (800) to a network (not shown) (e.g., a local area network (LAN), a wide area network (WAN), such as the Internet, mobile network, or any other type of network) or to another device, such as another computing device, and combinations thereof.

Further, the output device(s) (812) may include a display device, a printer, external storage, or any other output device. One or more of the output device(s) (812) may be the same or different from the input device(s) (810). The input device(s) (810) and output device(s) (812) may be locally or remotely connected to the computer processor(s) (802). Many different types of computing systems exist, and the aforementioned input device(s) (810) and output device(s) (812) may take other forms. The output device(s) (812) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (802), is configured to perform one or more embodiments, which may include transmitting, receiving, presenting, and displaying data and messages described in the other figures of the disclosure.

The computing system (800) in FIG. 8.1 may be connected to, or be a part of, a network. For example, as shown in FIG. 8.2, the network (820) may include multiple nodes (e.g., node X (822) and node Y (824), as well as extant intervening nodes between node X (822) and node Y (824)). Each node may correspond to a computing system, such as the computing system shown in FIG. 8.1, or a group of nodes combined may correspond to the computing system shown in FIG. 8.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822) and node Y (824)) in the network (820) may be configured to provide services for a client device (826). The services may include receiving requests and transmitting responses to the client device (826). For example, the nodes may be part of a cloud computing system. The client device (826) may be a computing system, such as the computing system shown in FIG. 8.1. Further, the client device (826) may include or perform all or a portion of one or more embodiments.

The computing system of FIG. 8.1 may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining, for a particular entity, a plurality of tuples about emissions of the particular entity, each tuple comprising an amount, an emission type of a plurality of emission types, and an emission category of a plurality of emission categories;
populating, in a user interface, a circular emissions diagram with a plurality of emission indicators generated from the plurality of tuples,
wherein the circular emissions diagram comprises a wedge of a plurality of wedges for each emission category of the plurality of emission categories, and
wherein populating the circular emissions diagram comprises for each tuple of the plurality of tuples:
assigning an emission indicator of the plurality of emission indicators to a corresponding wedge of the plurality of wedges that corresponds to the emission category in the tuple, and
setting a radial distance from the center in the wedge of the emission indicator based on the amount in the tuple; and
displaying the user interface.

2. The method of claim 1, further comprising:
determining, for each tuple of the plurality of tuples and from the amount in the tuple, an intensity of the emission type in the emission category, and
using the intensity for the emission indicator.

3. The method of claim 2, wherein setting the radial distance from center based on the amount comprises using the intensity for the radial distance.

4. The method of claim 1, wherein the amount is directly used as a size of the emission indicator.

5. The method of claim 1, wherein the circular emission diagram comprises at least three concentric circles, each concentric circle corresponding to an individual threshold on a value based on the amount, the value corresponding to the radial distance.

6. The method of claim 5, wherein the individual threshold is on an intensity determined from the amount.

7. The method of claim 5, wherein each of the concentric circles are color coded.

8. The method of claim 5, wherein the greater emission for the concentric circles is toward the middle.

9. The method of claim 1, wherein the plurality of wedges corresponds to a scope 1 emission wedge, a scope 2 emission wedge, and a scope 3 emission wedge, wherein a size of the scope 1 emission wedge, the scope 2 emission wedge, and the scope 3 emission wedge match relative expected sizes of scope 1 emissions, scope 2 emissions, and scope 3 emissions respectively.

10. The method of claim 1, wherein the emission indicator an emission type label comprises displaying the emission type.

11. The method of claim 1, wherein the circular emission diagram further comprises an outer dotted circle labeled with a plurality of wedge labels.

12. A system comprising:
a data repository storing a plurality of tuples about emissions of a particular entity, each tuple comprising an amount, an emission type of a plurality of emission types, and an emission category of a plurality of emission categories; and
a computer processor connected to the data repository for generating a user interface comprising a circular emissions diagram comprising a plurality of emission indicators generated from the plurality of tuples,
wherein the circular emissions diagram comprises a wedge of a plurality of wedges for each emission category of a plurality of emission categories, and
wherein the circular emissions diagram comprises for each tuple of the plurality of tuples:
an emission indicator of the plurality of emission indicators in a corresponding wedge of the plurality of wedges that corresponds to the emission category in the tuple, and
wherein the emission indicator is at a radial distance from the center in the wedge defined based on the amount in the tuple.

13. The system of claim 12, wherein the radial distance from center is determined from an intensity for the radial distance, wherein the amount is used to determine the intensity.

14. The system of claim 12, wherein the amount is directly used as a size of the emission indicator.

15. The system of claim 12, wherein the circular emission diagram comprises at least three concentric circles, each concentric circle corresponding to an individual threshold on a value based on the amount, the value corresponding to the radial distance.

16. The system of claim 15, wherein each of the concentric circles are color coded.

17. The system of claim 15, wherein the greater emission for the concentric circles is toward the middle.

18. The system of claim 12, wherein the plurality of wedges corresponds to a scope 1emission wedge, a scope 2 emission wedge, and a scope 3 emission wedge, wherein a size of the scope 1 emission wedge, the scope 2 emission wedge, and the scope 3emission wedge match relative expected sizes of scope 1 emissions, scope 2 emissions, and scope 3 emissions respectively.

19. The system of claim 12, wherein the emission indicator an emission type label comprises displaying the emission type.

20. A non-transitory computer readable medium comprising computer readable program code for causing a computer system to perform operations comprising:
obtaining, for a particular entity, a plurality of tuples about emissions of the particular entity, each tuple comprising an amount, an emission type of a plurality of emission types, and an emission category of a plurality of emission categories;
populating, in a user interface, a circular emissions diagram with a plurality of emission indicators generated from the plurality of tuples,
wherein the circular emissions diagram comprises a wedge of a plurality of wedges for each emission category of a plurality of emission categories, and
wherein populating the circular emissions diagram comprises for each tuple of the plurality of tuples:
assigning an emission indicator of the plurality of emission indicators to a corresponding wedge of the plurality of wedges that corresponds to the emission category in the tuple, and
setting a radial distance from the center in the wedge of the emission indicator based on the amount in the tuple; and
displaying the user interface.
